(19) United States
(12) Patent Application Publication
(10) Pub. No.: US 2022/0158268 A1
(43) Pub. Date: May 19, 2022

(54) BATTERY PACK

(71) Applicant: SUBARU CORPORATION, Tokyo (JP)

(72) Inventors: Toshiaki NARUKE, Tokyo (JP); Hatsuhisa UEDA, Tokyo (JP); Tatsuya ISHIKAWA, Tokyo (JP)

(73) Assignee: SUBARU CORPORATION, Tokyo (JP)

(21) Appl. No.: 17/522,255

(22) Filed: Nov. 9, 2021

(30) Foreign Application Priority Data
Nov. 18, 2020 (JP) 2020-191678

(51) Int. Cl. H01M 10/63; B60L 50/60; B60L 58/26; H01M 50/204; H01M 50/249; H01M 10/613; H01M 10/625; H01M 10/656; H01M 10/48

(52) U.S. Cl. CPC H01M 10/63; B60L 50/60; B60L 58/26; H01M 50/204; H01M 2220/20; H01M 10/613; H01M 10/625; H01M 10/656; H01M 10/486; H01M 50/249

(57) ABSTRACT

A battery pack includes a battery, a cooler, a battery temperature detector, a reservoir tank, a fluid pump and an arithmetic and control unit. A cooling fluid to exchange heat with the battery is to circulate through an interior of the cooler. The battery temperature detector is configured to detect a temperature of the battery. The reservoir tank is configured to store the cooling fluid. The fluid pump is installed in a path along which the cooling fluid is to circulate. Based on the detected temperature, the arithmetic and control unit is configured to, upon cooling the battery, operate the fluid pump to circulate the cooling fluid to exchange heat between the battery and the cooling fluid circulating in the cooler, and upon retaining heat of the battery, store at least part of the cooling fluid in the reservoir tank to reduce the cooling fluid in the interior of the cooler.

### CROSS-REFERENCE TO RELATED APPLICATIONS

The present application claims priority from Japanese Patent Application No. 2020-191678 filed on Nov. 18, 2020, the entire contents of which are hereby incorporated by reference.

### BACKGROUND

The disclosure relates to a battery pack, particularly a battery pack that controls the temperature of a battery cell using a cooling fluid.

A storage battery that stores power for driving is mounted on an electric vehicle. The temperature of the storage battery is controlled so as to be within a certain temperature range. In other words, heating is performed so that the temperature of the storage battery is not equal to or lower than a lower limit temperature and cooling is performed so that the temperature of the storage battery is not equal to or higher than a higher limit temperature.

In addition, depending on the temperature condition of the storage battery, an output from the storage battery is sometimes restricted.

Japanese Unexamined Patent Application Publication (JP-A) No. H9-259940 discloses a battery pack cooling apparatus that cools a battery mounted on a vehicle by charging and releasing a coolant of a reservoir in and from a cooling space formed in such a shape to cover the battery.

### SUMMARY

An aspect of the disclosure provides a battery pack includes a battery, a cooler, a battery temperature detector, a reservoir tank, a fluid pump, and an arithmetic and control unit. A cooling fluid to exchange heat with the battery is to circulate through an interior of the cooler. The battery temperature detector is configured to detect a temperature of the battery. The reservoir tank is configured to store the cooling fluid. The fluid pump is installed in a path along which the cooling fluid is to circulate. Upon cooling the battery, the arithmetic and control unit is configured to, based on the temperature of the battery detected by the battery temperature detector, operate the fluid pump to circulate the cooling fluid to exchange heat between the battery and the cooling fluid circulating in the cooler. Upon retaining heat of the battery, the arithmetic and control unit is configured to, based on the temperature of the battery detected by the battery temperature detector, store at least part of the cooling fluid in the reservoir tank to reduce the cooling fluid in the interior of the cooler.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a side view illustrating a vehicle having a battery pack according to an embodiment of the disclosure.

FIG. 2 is a schematic view illustrating the battery pack according to the embodiment of the disclosure.

FIG. 3 is a block diagram illustrating a coupling configuration of the battery pack according to the embodiment of the disclosure.

FIG. 4 is a flowchart illustrating an operation of the battery pack according to the embodiment of the disclosure.

FIG. 5 is a sectional view illustrating a battery pack according to another embodiment of the disclosure.

FIG. 6 is a sectional view illustrating a battery pack according to another embodiment of the disclosure;

FIGS. 7A and 7B illustrate a battery pack according to another embodiment of the disclosure. FIG. 7A is a sectional view of the battery pack viewed from the lateral side, and FIG. 7B is a sectional view of the battery pack viewed from the rear side.

FIG. 8 illustrates a battery pack according to another embodiment of the disclosure and is a schematic view illustrating a reservoir tank and its peripheral configuration.

FIGS. 9A to 9D illustrate the battery pack of the embodiment of the disclosure, and they are schematic views illustrating respective configurations of a reservoir tank to generate a mixture, a fluid path, and other components.

FIGS. 10A to 10D illustrate the battery pack according to the embodiment of the disclosure, and they are schematic views illustrating a method for generating the mixture.

FIG. 11 is a flowchart illustrating the method for generating the mixture in the battery pack according to the embodiment of the disclosure.

FIG. 12 is a flowchart illustrating a method for sending air to a cooler in the battery pack according to the embodiment of the disclosure.

FIG. 13 is a flowchart illustrating a method for controlling the temperature of a battery cell in the battery pack according to the embodiment of the disclosure.

### DETAILED DESCRIPTION

A battery pack cooling apparatus of the above-described configuration has room for improvement from the viewpoint of effectively cooling a battery pack.

Specifically, the technology disclosed in JP-A No. H9-259940 cools a battery by circulating a coolant in a cooling space and causing heat-exchange with the battery. However, JP-A No. H9-259940 does not give consideration to a configuration for retaining heat of a battery pack when the battery pack is placed under a cooled environment.

It is desirable to provide a battery pack that can effectively cool and thermally insulate a battery module with a simple configuration.

Hereafter, a battery pack 14 according to an embodiment of the disclosure is described in detail based on the drawings. In the following description, all of front, rear, up, down, left and right are used to indicate directions. The left and right mean respectively left and right sides when a vehicle 10 is viewed from the rear side. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

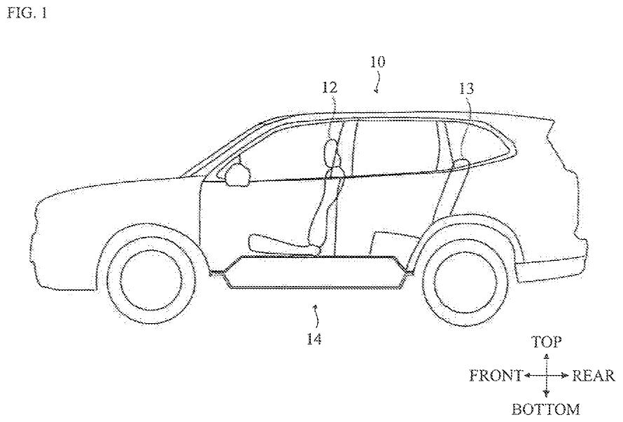

FIG. 1 is a side view illustrating the vehicle 10 having the battery pack 14. The battery pack 14 is mounted on the vehicle 10 to supply electric power to a motor and various electrical components of the vehicle 10. Examples of the vehicle 10 include an automobile and a train. Examples of the vehicle 10 also include an electric vehicle (EV), a hybrid electric vehicle (HEV) and a plug-in hybrid electric vehicle (PHEV).

The battery pack 14 is disposed below a front seat 12 and a rear seat 13. With this configuration, an area below the front seat 12 and the rear seat 13 can be effectively utilized. Further, placement of the battery pack 14 at such a position disposes a lower side of the battery pack 14 at a bottom side of the vehicle 10. Thus, traveling wind generated below the vehicle 10 during the vehicle 10 traveling can cool the battery pack 14.

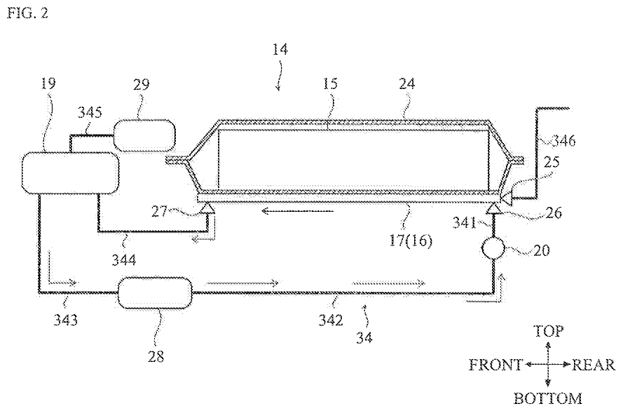

FIG. 2 is a schematic view illustrating a specific configuration of the battery pack 14.

The battery pack 14 mainly includes a battery module 15, a cooler 17 and a reservoir tank 19.

The battery module 15 supplies a current to a motor that gives a driving force to a vehicle body of the vehicle 10. As the battery module 15, a rechargeable battery such as a nickel-hydrogen battery or a lithium-ion battery may be employed. The battery module 15 is formed of a plurality of stacked battery cells that are not illustrated. In addition, the battery module 15 is disposed in an area enclosed by a battery storage case 24. The battery storage case 24 is formed of a metal plate or a synthetic resin plate.

The cooler 17 is disposed near the battery module 15, in this embodiment, below the battery module 15, and has an interior through which a cooling fluid 16 circulates to exchange heat with the battery module 15. As the cooling fluid 16, a liquid such as water and an antifreeze solution or a gas may be used. As described later, a mixed fluid of a liquid and a gas may be used as the cooling fluid 16. Further, the cooler 17 is disposed between the battery module 15 and the outside of the vehicle 10. This allows use of the travelling wind generated when the vehicle 10 travels for cooling the cooling fluid 16 flowing inside the cooler 17. Further, exposure of a lower surface of the cooler 17 to the outside of the vehicle 10 enhances this effect.

In this embodiment, when heat is exchanged between the battery module 15 and the cooling fluid 16, in other words, heat is exchanged between the battery cells included in the battery module 15 and the cooling fluid 16. In addition, when the temperature of the battery module 15 is controlled, in other words, the temperature of the battery cells constituting the battery module 15 is controlled. Further, the battery module 15 and the battery cells are a kind of battery.

A chiller 28 cools the cooling fluid 16, which has been heated by heat-exchange with the cooler 17. The chiller 28 is also called as a cooling water circulation system.

A fluid pump 20 circulates the cooling fluid 16. In one example, the fluid pump 20 circulates the cooling fluid 16 in the order of the cooler 17, a valve 27, a fluid path 344, the reservoir tank 19, a fluid path 343, the chiller 28, a fluid path 342, the fluid pump 20, a fluid path 341, a valve 26 and the cooler 17.

The reservoir tank 19 temporarily stores the cooling fluid 16 extracted from the cooler 17.

A gas pump 29 transfers air or a mixture 21 to the cooler 17, which will be described later.

Components constituting the battery pack 14 are coupled to one another via a fluid path 34. In one example, the fluid path 341 couples the cooler 17 and the fluid pump 20; the fluid path 342 couples the gas pump 20 and the chiller 28; and the fluid path 343 couples the chiller 28 and the reservoir tank 19. The fluid path 344 couples the reservoir 19 and the cooler 17; the fluid path 345 couples the reservoir tank 19 and the gas pump 29; and the fluid path 346 couples the cooler 17 to the outside of the vehicle 10. The fluid path 34 is a pipe conduit made of a metal or a synthetic resin.

A valve 25 is installed in a coupling portion between the cooler 17 and the fluid path 346. The valve 26 is installed in a coupling portion between the cooler 17 and the fluid path 341. The valve 27 is installed in a coupling portion between the cooler 17 and the fluid path 344.

As described later, in cooling the battery module 15 of the battery pack 14, the fluid pump 20 is operated to circulate the cooling fluid 16 thereby to exchange heat between the cooling fluid 16 flowing in the cooler 17 and the battery module 15. Meanwhile, in retaining heat of the battery module 15, part of the cooling fluid 16 is stored in the reservoir tank 19 thereby to reduce the cooling fluid 16 inside the cooler 17.

An end of the fluid path 346 that is not coupled to the cooler 17 is disposed at a higher position than positions where the components constituting the battery pack 14 are disposed. This allows air to be extracted from the cooler 17.

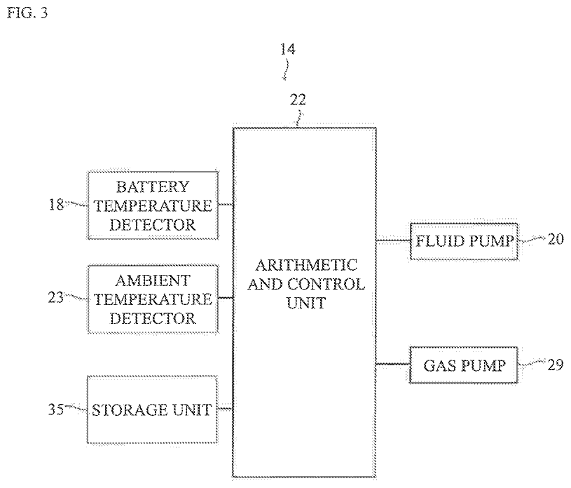

FIG. 3 is a block diagram illustrating a coupling configuration of the battery pack 14. The battery pack 14 has an arithmetic and control unit 22, a battery temperature detector 18, an ambient temperature detector 23, a storage unit 35, the fluid pump 20 and the gas pump 29.

The battery temperature detector 18 detects a temperature of the battery module 15.

The ambient temperature detector 23 detects a temperature of the outside of the battery pack 14, for example, a temperature of the outside of the vehicle 10.

The storage unit 35 is a random access memory (RAM) or a read only memory (ROM), and stores a program, a parameter, or the like to operate the battery pack 14.

The arithmetic and control unit 22 is, for example, a central processing unit (CPU). The arithmetic and control unit 22 includes one or more input terminals coupled to the battery temperature detector 18, the ambient temperature detector 23 and the storage unit 35, and one or more output terminals coupled to the fluid pump 20 and the gas pump 29. The arithmetic and control unit 22 controls operations of the fluid pump 20 and the gas pump 29 based on input information received from the battery temperature detector 18, the ambient temperature detector 23 and the storage unit 35. Further, the arithmetic and control unit 22 controls the opening-closing state of each valve such as the valve 26 illustrated in FIG. 2.

FIG. 4 is a flowchart illustrating an operation of the battery pack 14. With reference to FIG. 4, the operation of the battery pack 14 having the above configuration will be described.

In step S10, the arithmetic and control unit 22 uses the battery temperature detector 18 and the ambient temperature detector 23 to measure a battery temperature Tbat and an outside air temperature Tout at a surrounding of the vehicle 10.

In step S11, the arithmetic and control unit 22 determines whether the outside air temperature Tout is 0° C. or more.

In a case where the determination in step S11 is YES, that is the outside air temperature Tout is 0° C. or more, the arithmetic and control unit 22 proceeds to step S12.

In a case where the determination in step S11 is NO, that is the outside air temperature Tout is less than 0° C., the arithmetic and control unit 22 proceeds to step S18.

In step S12, the arithmetic and control unit 22 determines whether the cooler 17 is filled with the cooling fluid 16.

In a case where the determination in step S12 is YES, that is the cooler 17 is filled with the cooling fluid 16, the arithmetic and control unit 22 proceeds to step S15.

In a case where the determination in step S12 is NO, that is the cooler 17 is not filled with the cooling fluid 16, the arithmetic and control unit 22 proceeds to step S13.

In step S13, the arithmetic and control unit 22 opens the valves 26 and 27.

In step S14, the arithmetic and control unit 22 operates the fluid pump 20. With reference to FIG. 2, this allows the cooling fluid 16 stored in the reservoir tank 19 to be flown into the cooler 17 through the fluid path 343, the chiller 28, the fluid path 342, the fluid pump 20, the fluid path 341 and the valve 26 by a pressure applied by the fluid pump 20. The arithmetic and control unit 22 operates the fluid pump 20 until the cooler 17 is filled with the cooling fluid 16. When step S14 ends, the arithmetic and control unit 22 returns to step S12.

In step S15, the arithmetic and control unit 22 determines whether the battery temperature Tbat of the battery module 15 measured by the battery temperature detector 18 is a preset threshold or more. The threshold used herein is an upper limit value of a temperature range that can ensure discharge and charge characteristics of the battery module 15, and for example, 0° C.

In a case where the determination in step S15 is YES, that is the battery temperature Tbat is a preset threshold or more, the arithmetic and control unit 22 proceeds to step S16.

In a case where the determination in step S15 is NO, the arithmetic and control unit 22 proceeds to step S17. When the determination in step S15 is NO, the battery temperature Tbat is less than the preset threshold. The battery module 15 having such temperature Tbat has been sufficiently cooled by circulating the cooling fluid 16 cooled by chiller 28 by the fluid pump 20. Therefore, the arithmetic and control unit 22 proceeds to step S17.

In step S16, the arithmetic and control unit 22 operates the chiller 28 and the fluid pump 20. In this situation, the valves 26 and 27 are opened. This allows the cooling fluid 16 to circulate in the order of the fluid path 341, the valve 26, the cooler 17, the valve 27, the fluid path 344, the reservoir tank 19, the fluid path 343, the chiller 28, the fluid path 342 and the fluid pump 20. This exchanges heat between the cooling fluid 16 flowing inside the cooler 17 and the battery module 15, thus cooling the battery module 15.

In step S17, the arithmetic and control unit 22 stops the fluid pump 20 and the chiller 28 since the battery module 15 has been sufficiently cooled by the above step S16.

In step S18, the arithmetic and control unit 22 determines whether the battery temperature Tbat of the battery module 15 measured by the battery temperature detector 18 is equal to or less than a threshold. The threshold mentioned herein is, for example, 0° C.

In a case where the determination in step S18 is YES, that is the battery temperature Tbat is equal to or less than the preset threshold, the arithmetic and control unit 22 proceeds to step S19.

In a case where the determination in step S18 is NO, that is the battery temperature That is higher than the preset threshold, the arithmetic and control unit 22 proceeds to step S12.

In step S19, the arithmetic and control unit 22 causes the valve 26 to be closed.

In step S20, the arithmetic and control unit 22 operates the gas pump 29. This causes the cooling fluid 16 stored in the cooler 17 to be transferred to the reservoir tank 19 via the valve 27 and the fluid path 344. That is, the reduction of the cooling fluid 16 inside the cooler 17 causes the cooler 17 to be used as a heat-insulating layer, which will be described later.

In step S21, the arithmetic and control unit 22 determines whether the cooling fluid 16 has been pulled out from the cooler 17. This determination can be made based on the amount of the cooling fluid 16 that has been flown into the reservoir tank 19. Further, this determination can be made when the operating period of the gas pump 29 becomes a certain level or more.

In a case where the determination in step S21 is YES, that is almost all of the cooling fluid 16 has been extracted from the cooler 17, the arithmetic and control unit 22 proceeds to step S22.

In a case where the determination in step S21 is NO, that is the cooling fluid 16 has not yet been extracted from the cooler 17, the arithmetic and control unit 22 returns to step S20 to operate the gas pump 29 and continue extracting the cooling fluid 16 from the cooler 17.

In step S22, the arithmetic and control unit 22 further continues suction by the gas pump 29.

In this step, the gas pump 29 continues sucking air in the interior of the cooler 17 until the interior of the cooler 17 becomes a substantially vacuum state or a predetermined depressurized state. In this step, until a certain period of time has passed, the gas pump 29 may continue the suction, thereby bringing the interior of the cooler 17 into the substantially vacuum state or the predetermined depressurized state. Further, until an interior atmospheric pressure measured by a sensor disposed at the cooler 17 becomes a predetermined value, the gas pump 29 may continue the suction, thereby bringing the interior of the cooler 17 into the substantially vacuum state or the predetermined depressurized state. This allows an interior space of the cooler 17 to serve as a heat-insulating layer, reducing heat exchange between the battery module 15 and the outside and retaining heat of the battery module 15.

In step S23, the arithmetic and control unit 22 causes the valves 26 and 27 to be closed. This can maintain the interior of the cooler 17 in the substantially vacuum state or the predetermined depressurized state. Thus, the cooler 17 serves as a heat-insulating layer and is allowed to retain heat of the battery module 15.

In step S24, the arithmetic and control unit 22 determines whether the battery temperature Tbat measured by the battery temperature detector 18 is 0° C. or lower.

In a case where the determination in step S24 is YES, that is the battery temperature Tbat is 0° C. or lower, the arithmetic and control unit 22 proceeds to step S25.

When the determination in step S24 is NO, that is the battery temperature Tbat is higher than 0° C., the arithmetic and control unit 22 returns to step S10.

In step S25, the arithmetic and control unit 22 determines whether the vehicle 10 is in a plug-in state, that is whether the vehicle 10 is coupled with an external commercial power source or the like.

In a case where the determination in step S25 is YES, that is the vehicle 10 is in the plug-in state, the arithmetic and control unit 22 proceeds to step S26.

When the determination in step S25 is NO, that is the vehicle 10 is not in the plug-in state, the arithmetic and control unit 22 returns to step S10.

In step S26, the arithmetic and control unit 22 turns on a heater 30 to be described later, thereby heating the battery module 15 and preventing the battery module 15 from deteriorating in charge and discharge characteristics.

The operation of the battery pack 14 has been described above.

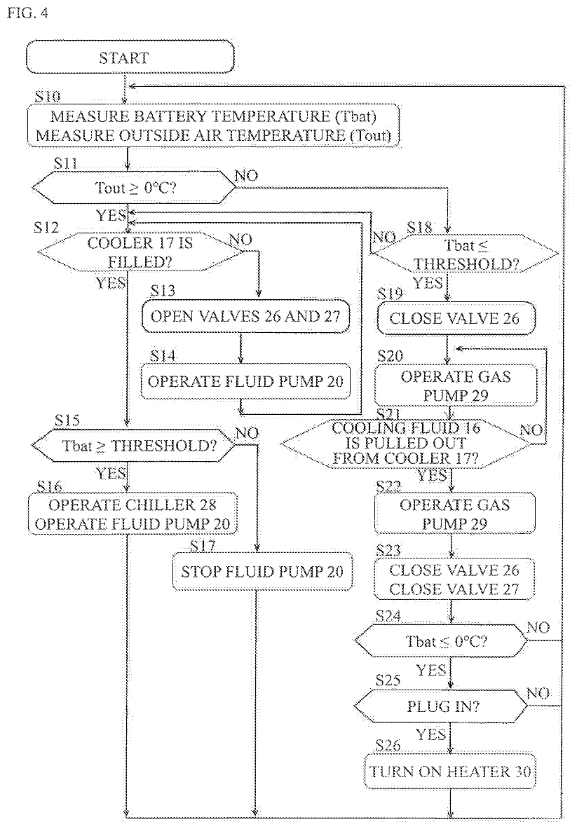

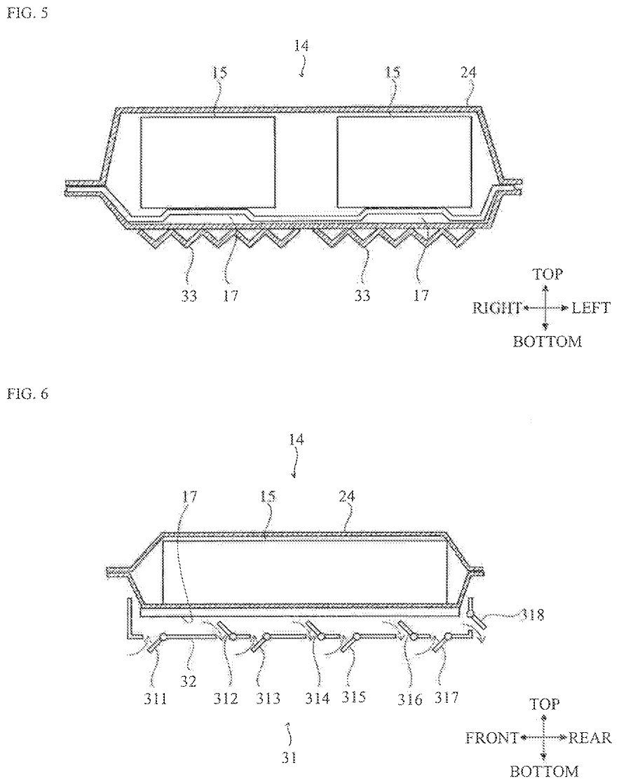

FIG. 5 is a sectional view illustrating a battery pack 14 according to another embodiment of the disclosure. A basic configuration of the battery pack 14 described herein is the same as the embodiment described by referring to FIG. 2, and a difference of the battery pack 14 in FIG. 5 from the battery pack 14 in FIG. 2 is that the battery pack 14 in FIG. 5 includes a radiating fin 33.

The radiating fin 33 is attached to an under surface of the battery storage case 24. The radiating fin 33 may be formed of a steel plate that is molded in a corrugated form in the width direction of the vehicle 10. In this embodiment, two battery modules 15 are accommodated in the battery storage case 24, and the radiating fin 33 is disposed below each battery module 15. In addition, the radiating fin 33 is exposed from an under surface of the vehicle 10 to the outside of the vehicle 10.

Further, the cooler 17 through which the cooling fluid 16 flows is formed below the battery module 15.

With this configuration, the radiation characteristics of the battery module 15 can be improved. That is, heat generated from the battery module 15 is released to the outside of the vehicle 10 via the cooler 17, the under surface of the battery storage case 24 and the radiating fin 33. This prevents the battery module 15 from being overheated. Further, even when a bottom surface of the vehicle body of the vehicle 10 is in contact with a ground, the radiating fin 33 and the cooler 17 works like a cushion to reduce an input to the battery module 15.

FIG. 6 is a sectional view illustrating a battery pack 14 according to another embodiment of the disclosure. A basic configuration of the battery pack 14 described herein is the same as the embodiment described by referring to FIG. 2, and a difference of the battery pack 14 in FIG. 6 from the battery pack 14 in FIG. 2 is that the battery pack 14 in FIG. 6 includes openable-closable members 31.

For example, a body floor 32 is disposed below the battery pack 14 and the openable-closable members 31 (openable-closable members 311 to 318) are attached to the body floor 32. Each of the openable-closable members 311 to 318 is attached to the body floor 32 in an openable-closable state with a rear-side end as a pivot. In this embodiment, the openable-closable members 311, 313, 315, 317 and 318 are openable outward while the openable-closable members 312, 314 and 316 are openable inward.

With this configuration, air flows along the openable-closable member 311 thereby to cool the cooler 17 and is released to the outside through the openable-closable member 312. Thus, while the vehicle 10 is travelling, air introduced from the outside of the vehicle 10 is effectively applied to an under surface of the cooler 17 to effectively cool the battery module 15 in a ripple effect manner.

Meanwhile, in a case where heat exchange between the battery module 15 and the outside air is not desired, for example, a case where the outside air temperature is high, a case where the battery module 15 is forcibly cooled, or a case where the outside air temperature is extremely low, the openable-closable member 31 is brought into a closed state to thermally insulate the battery module 15 from an outside atmosphere.

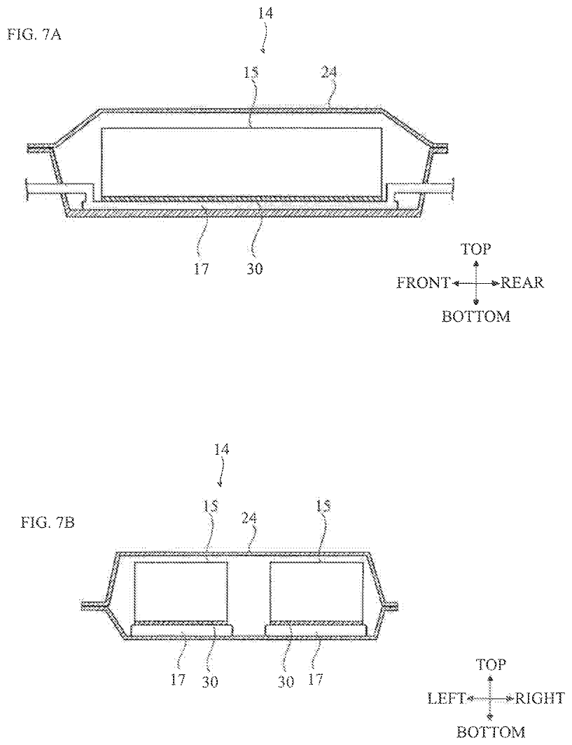

FIGS. 7A and 7B illustrate a battery pack 14 according to another embodiment of the disclosure. FIG. 7A is a sectional view of the battery pack 14 viewed from the lateral side of the vehicle 10; and FIG. 7B is a sectional view of the battery pack 14 viewed from the rear side of the vehicle 10. A basic configuration of the battery pack 14 described herein is the same as the embodiment described by referring to FIG. 2, and the difference of the battery pack 14 in FIGS. 7A and 7B from the battery pack 14 in FIG. 2 is that the battery pack 14 in FIGS. 7A and 7B includes the heater 30.

The heater 30 is disposed between an under surface of the battery module 15 and a top surface of the cooler 17. The heater 30 is, for example an electric heater that generates heat by energization. Based on an instruction of the arithmetic and control unit 22 described above, the heater 30 generates heat when the temperature of the battery module 15 or the outside air temperature is low. With this configuration, the battery module 15 is suitably heated to prevent the discharge and charge characteristics from being deteriorated. Further, in this embodiment, the amount of fluid inside the cooler 17 is at least partially reduced, which will be described later, and thereby allowing the cooler 17 to serve as a heat-insulating layer and retain heat of the battery module 15.

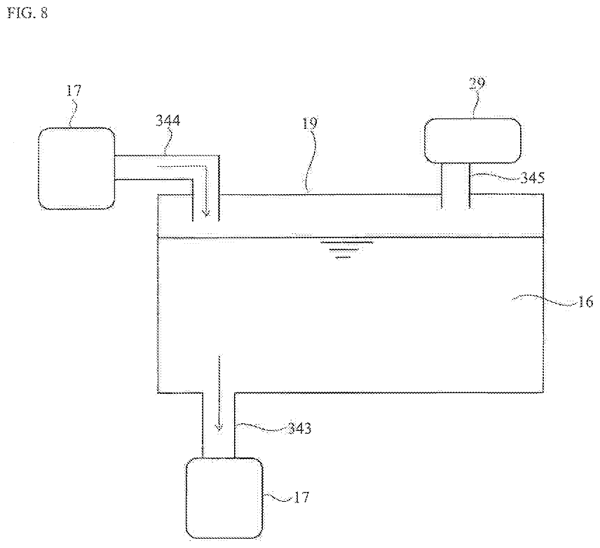

FIG. 8 is a schematic view illustrating the reservoir tank 19 and its peripheral configuration.

The fluid path 345 connects the gas pump 29 and the reservoir tank 19 and is coupled to the reservoir tank 19 to a top surface of the reservoir tank 19. A lower end of the fluid path 345 is configured not to be in contact with a fluid surface of the cooling fluid 16. This configuration prevents the cooling fluid 16 from entering into the gas pump 29.

The fluid path 344 allows the cooling fluid 16 to flow from the cooler 17 to the reservoir tank 19 through the fluid path 344, and is coupled to the top surface of the reservoir tank 19.

The fluid path 343 allows the cooling fluid 16 to flow from the reservoir tank 19 to the cooler 17 through the fluid path 343, and is coupled to the bottom surface of the reservoir tank 19.

With this configuration, when suction is performed by the gas pump 29, the cooling fluid 16 from the cooler 17 flows into the reservoir tank 19 through the fluid path 344. In addition, even when all of the cooling fluid 16 stored in the cooler 17 is transferred to the reservoir tank 19, the fluid surface of the cooling fluid 16 does not make contact with the lower end of the fluid path 345, thereby preventing the cooling fluid 16 from reaching to the gas pump 29.

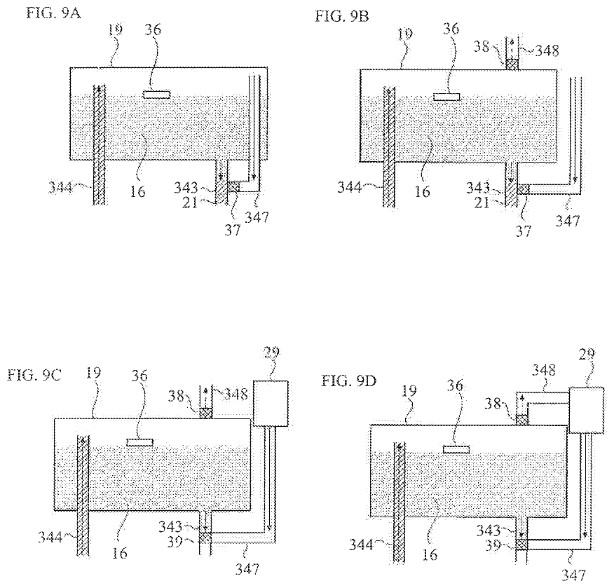

With reference to FIGS. 9 to 12, operation is described in which a gas or a frothy mixture 21 composed of the cooling fluid 16 and a gas is introduced into the cooler 17 to serve an interior space of the cooler 17 as a heat-insulating layer and to retain heat of the battery module 15.

FIGS. 9A, 9B, 9C and 9D are schematic views illustrating respective embodiments of the reservoir tank 19, fluid paths and others. In these figures, the cooling fluid 16 in the form of a liquid is indicated by dot hatching and the mixture 21 is indicated by diagonal hatching.

The mixture 21 is sent to the cooler 17 from the reservoir tank 19 illustrated in FIGS. 9A and 9B. Meanwhile, a gas is sent to the cooler 17 from the reservoir tank 19 illustrated in FIGS. 9C and 9D.

With reference to FIG. 9A, the reservoir tank 19 is communicated with the fluid paths 344 and 343.

The fluid path 344 is coupled to a bottom surface of the reservoir tank 19 and the fluid path 344 includes an upper end disposed above the fluid surface of the cooling fluid 16.

The fluid path 343 is coupled to the bottom surface of the reservoir tank 19.

The fluid path 347 is communicated with a halfway section of the fluid path 343 and an interior of the reservoir tank 19. A lower end of the fluid path 347 is coupled to the halfway section of the fluid path 343. In addition, the fluid path 347 is coupled to the reservoir tank 19 through the bottom surface of the reservoir tank 19, and an upper end of the fluid path 347 is disposed above the fluid surface of the cooling fluid 16. This configuration can introduce a gas inside the reservoir tank 19 into the fluid path 343 at the halfway section of the fluid path 343.

A valve 37 is disposed near a coupling portion between the fluid paths 343 and 347 and installed on the side of the fluid path 347.

A floater 36 is formed of a material such as a foam resin having a smaller specific gravity than the cooling fluid 16. The floater 36 floats on the fluid surface of the cooling fluid 16. The arithmetic and control unit 22 detects the amount of the cooling fluid 16 stored in the reservoir tank 19 based on the height of the floater 36 inside the reservoir tank 19.

For sending the mixture 21 to the cooler 17, the valve 37 is opened and the above-described fluid pump 20 is operated, whereby the cooling fluid 16 in the reservoir tank 19 is flown toward the cooler 17 through the fluid path 343. At that time, a gas inside the reservoir tank 19 is mixed with the cooling fluid 16 flowing through the fluid path 343 by Venturi effect, whereby the mixture 21 is produced by mixing the cooling fluid 16 with the gas. The produced mixture 21 is sent to the cooler 17. Further, the mixture 21 sent to the cooler 17 returns to the reservoir tank 19 through the fluid path 344 and then is subjected to gas-liquid separation inside the reservoir tank 19.

The gas inside the reservoir tank 19 is circulated as the mixture 21 together with the cooling fluid 16.

Thus, any gas such as air or nitrogen can be employed as the gas forming the mixture 21. Further, as the gas for forming the mixture 21, a gas having high heat-insulating properties such as argon gas is employed, thereby enhancing an effect of the mixture 21 to retain heat of the battery module 15.

A basic configuration of the reservoir tank 19 and other components illustrated in FIG. 9B is the same as the configuration illustrated in FIG. 9A. In the embodiment of FIG. 9B, the upper end of the fluid path 347 is disposed outside the reservoir tank 19. In addition, a fluid path 348 configured to communicate the top surface of the reservoir tank 19 with the outside is disposed and a valve 38 is installed on the fluid path 348. Opening of the valve 38 in accordance with an inner pressure of the reservoir tank 19 can prevent an excessive increase in inner pressure of the reservoir tank 19.

For sending the mixture 21 to the cooler 17, the valve 37 is opened and the above-described fluid pump 20 is operated, whereby the cooling fluid 16 in the reservoir tank 19 is flown toward the cooler 17 through the fluid path 343. At that time, an outside gas is mixed with the cooling fluid 16 flowing through the fluid path 343 by Venturi effect, whereby the mixture 21 is produced by mixing the cooling fluid 16 with the gas. The produced mixture 21 is sent to the cooler 17.

In addition, when opening of the valve 38 introduces the cooling fluid 16 into the reservoir tank 19, the gas inside the reservoir tank 19 according to the amount of the introduced cooling fluid 16 is released outside from the fluid path 348. This can prevent an increase in inner pressure of the reservoir tank 19.

With this configuration, since the mixture 21 is produced by using an outside gas, it is not necessary to store a gas for producing the mixture 21 inside the reservoir tank 19, thereby downsizing the reservoir tank 19.

The configuration of the reservoir tank 19 and other components illustrated in FIG. 9C is basically the same as one illustrated in FIG. 9B, except that the configuration in FIG. 9C has a gas pump 29.

A lower end of the fluid path 347 is coupled to a halfway section of the fluid path 343 and an upper end of the fluid path 347 is coupled to the gas pump 29.

A three-way valve 39 is installed at a portion in the fluid path 343 coupled to the fluid path 347. Switching of the valve 39 can send the cooling fluid 16 stored in the reservoir tank 19 to the cooler 17 via the fluid path 343. Further, switching of the valve 39 in another direction can send air pressurized by and sent from the gas pump 29 toward the cooler 17 via the fluid paths 347 and 343.

For sending the cooling fluid 16 to the cooler 17, the valve 39 is operated to communicate an upstream and a downstream of the fluid path 343 with each other. The fluid pump 20 illustrated in FIG. 2 is operated in this state, whereby the cooling fluid 16 inside the reservoir tank 19 is sent to the cooler 17 via the fluid path 343.

For sending air to the cooler 17, the valve 39 is operated so as to communicate a downstream portion of the fluid path 343 below the valve 39 with the fluid path 347. The gas pump 29 is operated in this state, whereby a pressure generated by the gas pump 29 causes outside air to be sent to the cooler 17 via the fluid paths 347 and 343, and the other paths.

According to the configuration of the reservoir tank 19 and the other components illustrated in FIG. 9C, the gas pump 29 sends the air taken from the outside of the reservoir tank 19 to the cooler 17 via the fluid path 347 and the other paths. This enables the downsizing of the reservoir tank 19.

The configuration of the reservoir tank 19 and other components illustrated in FIG. 9D is basically the same as the configuration illustrated in FIG. 9C, except that, in the configuration of FIG. 9C, the gas pump 29 is coupled to the reservoir tank 19 via the fluid path 348.

In one example, the gas pump 29 has a discharge side coupled to the halfway section of the fluid path 343 via the fluid path 347. The gas pump 29 has a suction side coupled to the top surface of the reservoir tank 19 via the fluid path 348. In addition, the valve 38 is installed at a halfway section of the fluid path 348.

For sending the cooling fluid 16 to the cooler 17, the valve 39 is operated so as to communicate the upstream and the downstream of the fluid path 343 with each other, whereby the valve 38 is opened. When the fluid pump 20 illustrated in FIG. 2 is operated in this state, the cooling fluid 16 inside the reservoir tank 19 is sent to the cooler 17 via the fluid path 343.

For sending air to the cooler 17, the valve 39 is operated so as to communicate a downstream portion of the fluid path 343 below the valve 39 with the fluid path 347. Further, the valve 38 is opened. The gas pump 29 is operated in this state, whereby a pressure generated from the gas pump 29 causes a gas inside the reservoir tank 19 to be sent to the cooler 17 via the fluid path 348, the gas pump 29, the fluid path 343 and the other paths.

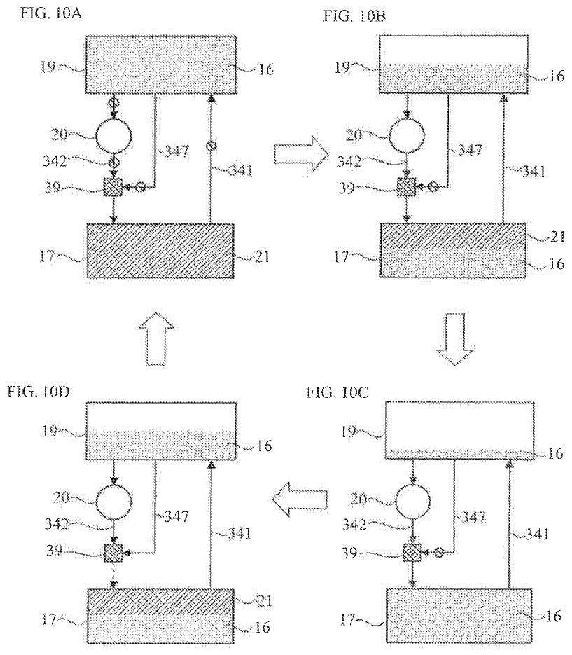

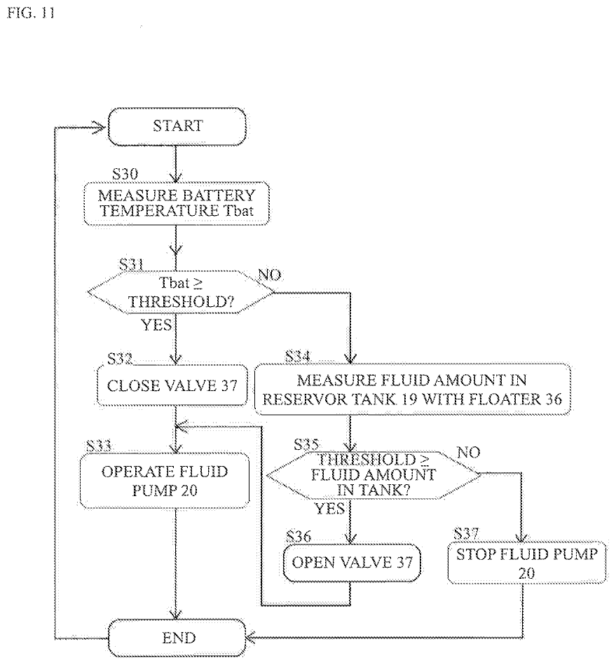

FIGS. 10A to 10D are schematic views sequentially illustrating a method for injecting the mixture 21 or the cooling fluid 16 into the cooler 17.

With reference to FIG. 10A, the cooler 17 is filled with the mixture 21 and the reservoir tank 19 is filled with the cooling fluid 16. In this figure, the fluid path 341, the fluid path 347 and the fluid path 342 are closed. This configuration allows the mixture 21 charged into the cooler 17 to serve as a heat-insulating layer, thereby retaining heat of the above-described battery module 15.

With reference to FIG. 10B, the fluid pump 20 is operated to introduce the cooling fluid 16 inside the reservoir tank 19 into the cooler 17 through the fluid path 342. Accordingly, the mixture 21 stored in the cooler 17 is transferred to the reservoir tank 19 through the fluid path 341. At the reservoir tank 19, foam separation occurs and whereby, the mixture 21 is changed to the cooling fluid 16.

With reference to FIG. 10C, the fluid pump 20 continues transferring the cooling fluid 16, whereby the cooler 17 is filled with the cooling fluid 16. Circulation of the cooling fluid 16 in this state can effectively cool the above-described battery module 15.

With reference to FIG. 10D, the fluid pump 20 is operated to inject the mixture 21 into the cooler 17. This transfers the cooling fluid 16 from the cooler 17 to the reservoir tank 19. Thereafter, as illustrated in FIG. 10A, the cooler 17 is filled with the mixture 21.

FIG. 11 is a flowchart of a method for cooling the battery module 15 or retaining heat of the battery module 15 in the configuration of the reservoir tank 19 illustrated in FIGS. 9A and 9B. In this method, for retaining heat of the battery module 15, the mixture 21 is charged into the cooler 17.

In step S30, the arithmetic and control unit 22 measures the battery temperature Tbat with the battery temperature detector 18.

In step S31, the arithmetic and control unit 22 checks whether the battery temperature Tbat is a preset threshold (for example, 0° C.) or more.

When the checking result is YES in step S31, the arithmetic and control unit 22 proceeds to step S32.

When the checking result is NO in step S31, the arithmetic and control unit 22 proceeds to step S34.

In step S32, the valve 37 illustrated in FIGS. 9A and 9B is closed to cool the battery module 15 based on an instruction of the arithmetic and control unit 22.

In step S33, the fluid pump 20 illustrated in FIG. 2 is operated based on an instruction of the arithmetic and control unit 22 to circulate the cooling fluid 16, thereby cooling the battery module 15.

In step S34, for retaining heat of the battery module 15, the arithmetic and control unit 22 measures the height position of the floater 36, thereby measuring the amount of the cooling fluid 16 inside the reservoir tank 19.

In step S35, the arithmetic and control unit 22 determines whether the amount of the cooling fluid 16 inside the reservoir tank 19 is equal to or less than a predetermined threshold. In this method, a small amount of the cooling fluid 16 inside the reservoir tank 19 indicates that the amount of the cooling fluid 16 charged into the cooler 17 is large. In addition, a large amount of the cooling fluid 16 charged into the cooler 17 indicates that the amount of the mixture 21 charged into the cooler 17 is small.

When the determination in step S35 is YES, the arithmetic and control unit 22 proceeds to step S36 to charge the mixture 21 into the cooler 17.

When the determination in step S35 is NO, the arithmetic and control unit 22 proceeds to step S37 since the cooler 17 is sufficiently filled with the mixture 21 and it is not necessary to send the mixture 21 further to the cooler 17.

In step S36, the arithmetic and control unit 22 opens the valve 37 and mixes the cooling fluid 16 with air, thereby realizing an environment for enabling generation of the mixture 21. When step S36 ends, the arithmetic and control unit 22 proceeds to step S33.

In step S37, the arithmetic and control unit 22 stops the fluid pump 20.

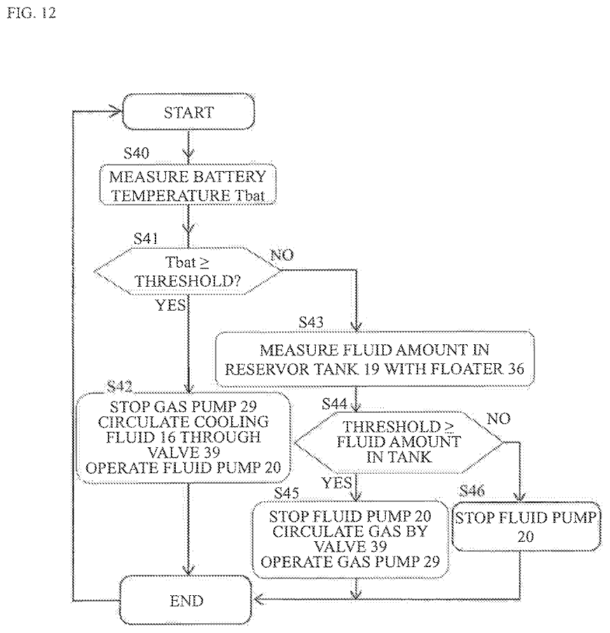

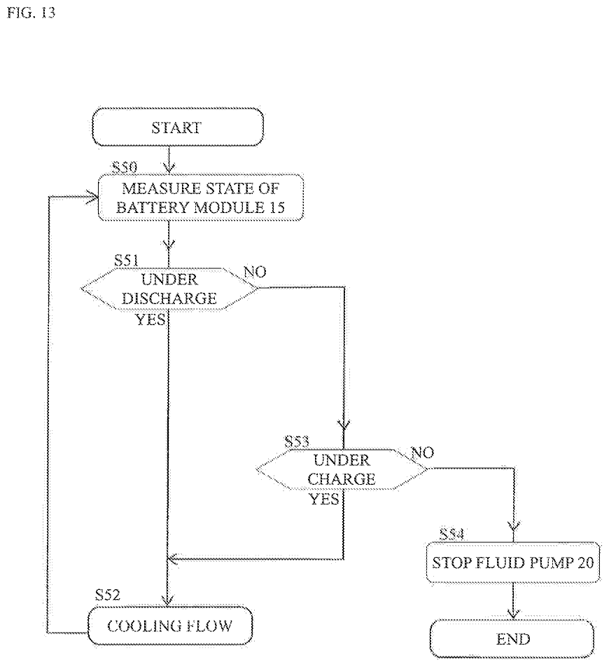

FIG. 12 is a flowchart of a method for cooling the battery module 15 or retaining heat of the battery module 15 in the configuration of the reservoir tank 19 illustrated in FIGS. 9C and 9D. In this method, heat in the battery module 15 is kept by emptying the cooler 17.

In step S40, the arithmetic and control unit 22 measures the battery temperature Tbat with the battery temperature detector 18.

In step S41, the arithmetic and control unit 22 checks whether the battery temperature Tbat is equal to or higher than a preset threshold (for example, 0° C.).

When the checking result in step S41 is YES, the arithmetic and control unit 22 proceeds to step S42.

When the checking result in step S41 is NO, the arithmetic and control unit 22 proceeds to step S43.

In step S42, based on an instruction of the arithmetic and control unit 22, the gas pump 29 is stopped with reference to FIGS. 9C and 90 to cool the battery module 15. Further, based on an instruction of the arithmetic and control unit 22, the upstream section and the downstream section of the fluid path 343 are communicated with each other by the valve 39, and further the fluid pump 20 is operated. This circulates the cooling fluid 16 to cool the battery module 15.

In step S43, for retaining heat of the battery module 15, the arithmetic and control unit 22 measures the height position of the floater 36, thereby measuring the amount of the cooling fluid 16 inside the reservoir tank 19.

In step S44, the arithmetic and control unit 22 determines whether the amount of the cooling fluid 16 inside the reservoir tank 19 is equal to or less than a predetermined threshold. In this method, a small amount of the cooling fluid 16 inside the reservoir tank 19 indicates that the amount of the cooling fluid 16 charged into the cooler 17 is large.

When the determination in step S44 is YES, the arithmetic and control unit 22 proceeds to step S45 to charge the mixture 21 into the cooler 17.

When the determination is NO in step S44, the arithmetic and control unit 22 proceeds to step S46 since the mixture 21 is sufficiently charged into the cooler 17 and it is not necessary to send the mixture 21 further to the cooler 17.

In step S45, the arithmetic and control unit 22 stops the fluid pump 20 and switches the valve 39 whereby the downstream portion of the fluid path 343 and the fluid path 347 are communicated with each other, and the gas pump 29 is operated. This allows a gas such as air to be introduced into the cooler 17, so that the cooling fluid 16 is transferred from the cooler 17 to the reservoir tank 19.

In step S46, the arithmetic and control unit 22 stops the fluid pump 20.

FIG. 13 is a flowchart of a method for detecting a state of the battery module 15 and cooling the battery module 15.

In step S50, the arithmetic and control unit 22 measures the state of the battery module 15.

In step S51, the arithmetic and control unit 22 determines whether the battery module 15 is under discharge.

When the determination in step S51 is YES, that is the battery module 15 is under discharge, the arithmetic and control unit 22 proceeds to step S52.

When the determination in step S51 is NO, that is the battery module 15 is not under discharge, the arithmetic and control unit 22 proceeds to step S53.

In step S52, the arithmetic and control unit 22 executes a flow for cooling the battery module 15 as described above. That is, the above-described steps such as step S16 are executed.

In step S53, the arithmetic and control unit 22 determines whether the battery module 15 is under charge.

When the determination in step S53 is YES, that is the battery module 15 is under charge, the arithmetic and control unit proceeds to step S52.

When the determination in step S53 is NO, that is the battery module 15 is not under charge, the arithmetic and control unit 22 proceeds to step S54.

In step S54, the arithmetic and control unit 22 stops the fluid pump 20 since it is not necessary to execute the cooling flow.

The configuration and operation of the battery pack 14 according to the embodiments has been described above.

The above-described embodiments can produce the following main effects.

In the embodiments, upon cooling the battery module 15, the fluid pump 20 is operated to circulate the cooling fluid 16, thereby causing heat exchange between the battery module 15 and the cooling fluid 16 flowing in the cooler 17. Accordingly, an excessive increase in the temperature of the battery module 15 is restrained. Meanwhile, for retaining heat of the battery module 15, the cooling fluid 16 inside the cooler 17 is reduced, which allows the cooler 17 to function as a heat-insulating layer. Accordingly, an excessive decrease in the temperature of the battery module 15 is restrained. Thus, the temperature of the battery module 15 can be kept in a suitable temperature range, thereby preventing the deterioration of the discharge and charge characteristics of the battery module 15.

Further, the cooler 17 is disposed between the battery module 15 and the outside of the vehicle. Upon cooling the battery module 15, this disposition allows the cooling fluid 16 flowing in the cooler 17 to be cooled by an outside air, so that the cooling fluid 16 can be effectively cooled. In addition, upon retaining heat of the battery module 15, the cooler 17 is used as a heat-insulating member, and this restrains heat-exchange between the outside air and the battery module 15, so that the battery module 15 can be retained heat of the battery module 15.

Furthermore, exposure of the cooler 17 to the outside of the vehicle 10 can utilize an outside air, and can further positively cool the cooling fluid 16 flowing in the cooler 17.

In addition, extracting the cooling fluid 16 from the interior of the cooler 17 can improve the effect of the cooler 17 as a heat-insulating material.

Further, upon retaining heat of the battery module 15, a pressure reduction in the interior of the cooler 17 can further improve the effect of the cooler 17 as the heat-insulating material.

Furthermore, upon retaining heat of the battery module 15, the frothy mixture 21 composed of the cooling fluid 16 and a gas is introduced into the interior of the cooler 17 to serve as a heat-insulating layer, thereby effectively retaining heat of the battery module 15.

Some example embodiments of the disclosure have been described above. The disclosure is not limited to these example embodiments and may be modified within the scope of the technology. The example embodiments described above may be combined as appropriate.

While the cooling fluid 16 is cooled by the chiller 28 in FIG. 2, a radiator may be employed instead of the chiller 28.

1. A battery pack comprising:
a battery;
a cooler having an interior through which a cooling fluid to exchange heat with the battery is to circulate;
a battery temperature detector configured to detect a temperature of the battery;
a reservoir tank configured to store the cooling fluid;
a fluid pump installed in a path along which the cooling fluid is to circulate; and
an arithmetic and control unit,
wherein, based on the temperature of the battery detected by the battery temperature detector:
upon cooling the battery, the arithmetic and control unit is configured to operate the fluid pump to circulate the cooling fluid, thereby to exchange heat between the battery and the cooling fluid circulating in the cooler; and
upon retaining heat of the battery, the arithmetic and control unit is configured to store at least part of the cooling fluid in the reservoir tank to reduce the cooling fluid in the interior of the cooler.

2. The battery pack according to claim 1, wherein the cooler is disposed between the battery and an outside of a vehicle.

3. The battery pack according to claim 1, wherein, upon retaining heat of the battery, the cooling fluid is extracted from the interior of the cooler.

4. The battery pack according to claim 1, wherein, upon retaining heat of the battery, the interior of the cooler is depressurized.

5. The battery pack according to claim 1, wherein, upon retaining heat of the battery, a frothy mixture comprising the cooling fluid and a gas is introduced into the interior of the cooler.
